(19) United States
(12) Patent Application Publication
(10) Pub. No.: US 2025/0136874 A1
(43) Pub. Date: May 1, 2025

(54) PROCESSES AND APPARATUSES FOR HEATING A HYDROCARBON PROCESS STREAM

(71) Applicant: UOP LLC, Des Plaines, IL (US)

(72) Inventors: Aziz Sattar, Itasca, IL (US); Sean Dalton, New Haven, CT (US); Trung Pham, Mount Prospect, IL (US); Chintan Surendra Shah, Haryana (IN); Soumendra Mohan Banerjee, New Delhi (IN); Sara Assarattanakul Williams, Arlington Heights, IL (US)

(21) Appl. No.: 18/802,067

(22) Filed: Aug. 13, 2024

(30) Foreign Application Priority Data
Oct. 27, 2023 (IN) 202311073226

(51) Int. Cl. C10G 31/06; F16L 53/34

(52) U.S. Cl. CPC C10G 31/06; F16L 53/34

(57) ABSTRACT

Processes and apparatuses for heating a hydrocarbon process stream, with an electric heater to provide a portion of the heat requirement necessary for a chemical reaction to occur to one of the components of the hydrocarbon process stream. The electric heater may be used between two reaction zones which are arranged on top of each other. Additionally, reaction zones may be in reactors which are arranged in a polygon.

### CROSS-REFERENCES TO RELATED APPLICATIONS

This application claims the benefit of Indian Patent Applicant No. 202311073226 filed on Oct. 27, 2023, the entire disclosure of which is incorporated herein by way of reference.

### FIELD OF THE INVENTION

This invention relates generally to processes and apparatuses for heating a hydrocarbon process stream, and more particularly to processes and apparatuses that use an electric heater to provide a portion of the heat requirement to the hydrocarbon process stream.

### BACKGROUND OF THE INVENTION

There is increased focus on reducing fossil fuel consumption, improving efficiencies to reduce carbon dioxide footprint, and increasing dependency on renewable sources of energy. With the pivoting of the refining and petrochemical industries towards sustainable sources of energy like solar, wind, hydroelectric, nuclear, etc. and the making of more green electricity available, there is a desire to reduce the size of fired heaters for technologies like hydrocarbon reforming, dehydrogenation, isomerization, transalkylation, hydrotreating, and others.

Process heating of a feed stream is generally done by fired heating or by circulation of hot heat transfer fluid in contact with metallic conduit/vessel/pipe containing the pressurized feed. This heating itself generates carbon dioxide from combustion of hydrocarbon rich fuel gas There are many thermal resistances to efficient heat transfer between the heating sources and feed to be heated. In case of fired heating, only 60% of thermal energy generated by combustion is transferred to process feed. Fired heating can also create hot spots as heat flux imparted to metallic conduit/vessel/pipe containing the pressurized feed is often non-uniform heat due to proximity of flame front and conduit/vessel/pipe. The hot spot in metallic conduit/vessel/pipe can increase potential of metal catalyzed coking of feed. Additionally, fired heating itself generates carbon dioxide from combustion of hydrocarbon rich fuel gas.

Accordingly, it would be desirable to have more effective and efficient ways to heat process streams to address one or more of these shortcomings.

### SUMMARY OF THE INVENTION

The present invention addresses these problems by providing processes and apparatuses in which electric heating and heaters are utilized in various hydrocarbon processing zones and devices. In addition to reducing carbon impact, the present invention provides effective and efficient devices and processes which allow for a reduction in hot volume, pressure drop, and/or a reduction of non-thermal cracking.

Therefore, the present invention may be characterized, in at least one aspect, as providing an apparatus having: a plurality of reaction zones, each reaction zone having an inlet and an outlet, wherein the reaction zones are disposed on top of each other forming a stack having a longitudinal axis; a conduit configured to transfer an effluent from the outlet of a first reaction zone to the inlet of a second reaction zone, the conduit having a longitudinal axis parallel to the longitudinal axis of the stack; and, at least one electric heater associated with the conduit and configured to heat the effluent within the conduit.

The apparatus may also include a second conduit configured to transfer an effluent from the outlet of the second reaction zone to the inlet of a third reaction zone. The second conduit may have a longitudinal axis parallel to the longitudinal axis of the stack. At least one electric heater may be associated with the second conduit and configured to heat the effluent within the second conduit.

The at least one electric heater may comprise a plurality of electric heating elements, and longitudinal axes of the electric heating elements may extend parallel to the longitudinal axis of the stack.

The at least one electric heater may comprise a plurality of electric heating elements, and longitudinal axes of the electric heating elements may extend perpendicular to the longitudinal axis of the stack. The electric heating elements may be arranged into a plurality of bundles, and the bundles may have different directions of insertion into the conduit. The directions of insertion may alternate for adjacent bundles. The directions of insertion, when viewed along the longitudinal axis of the conduit, may rotate by between 1 to 179 degrees, or between 20 to 160 degrees, or approximately 90 degrees.

The conduit may comprise a first leg, a second leg, and an elbow connecting the first leg and the second leg. The at least one electric heater may extend through the elbow.

The apparatus may include a second plurality of reaction zones, each reaction zone from the second plurality of reaction zones having an inlet and an outlet, the reaction zones from the second plurality of reaction zones being disposed on top of each other forming a second stack. A second conduit configured to transfer an effluent from the outlet of the second reaction zone to the inlet of a third reaction zone may be provided. The third reaction zone may be from the second plurality of reaction zones. The second conduit may have a longitudinal axis parallel to the longitudinal axis of the stack. At least one electric heater may be associated with the second conduit and configured to heat the effluent within the second conduit.

The apparatus may further include a fired heater configured to heat a stream associated with a reaction zone from the plurality of reaction zones. The fired heater may have an inlet configured to receive a stream of a hydrogen fuel.

In the apparatus, one or more of the reaction zones may be radial flow reaction zones.

In another aspect of the present invention, the present invention may be generally characterized as providing system having a plurality of reactor vessels, the reactor vessels arranged in series with a first reactor and a last reactor, and, when viewed from above, the plurality of reactor vessels form a polygon, piping configured to transfer an effluent from an upstream reactor vessel from the plurality of reactor vessels to a downstream reactor vessel from the plurality of reactor vessels, and, at least one electric heater disposed in the piping between two of the reactor vessels from the plurality of reactor vessels.

The system may include an electric heater disposed in the piping between each of the reactor vessels from the plurality of reactor vessels.

The polygon may be a rectangle.

The reactor vessels from the plurality of reactor vessels may be located at vertices of the polygon.

An electric heater may be located at each vertex of the polygon.

The system may also include a regeneration vessel disposed inside of the polygon. Also, piping, configured to provide catalyst from the regeneration vessel to at least one of the reactor vessels from the plurality of reactor vessels, may be provided. For example, the reactor vessel may be the first reactor vessel. Additionally, or alternatively, the reactor vessel may be last reactor vessel.

The plurality of reactor vessels may include four reactor vessels and the polygon may be a rectangle. An electric heater may be disposed in the piping between each of the four reactor vessels.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

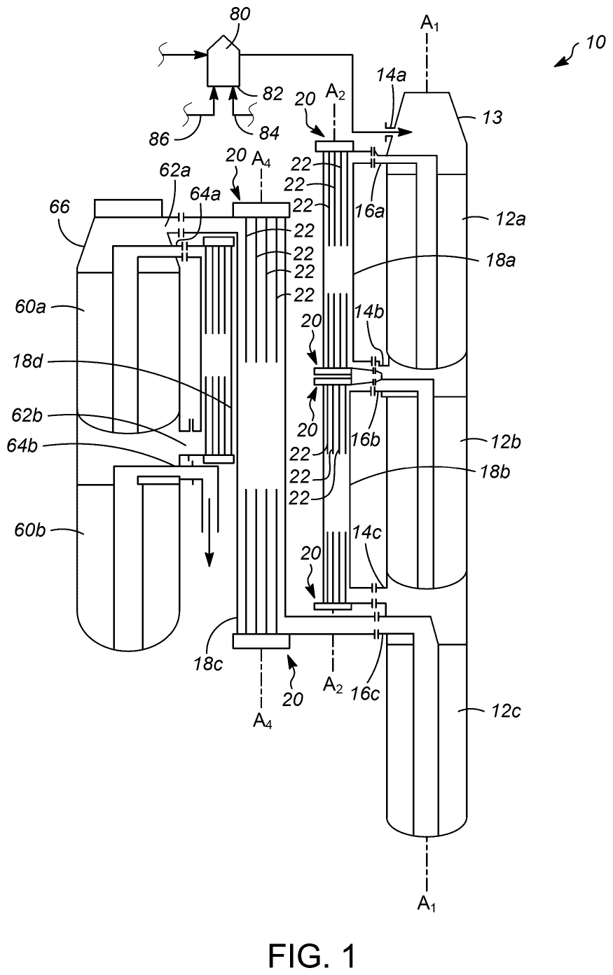

FIG. 1 is a schematic view of an apparatus according to one or more aspects of the present invention;

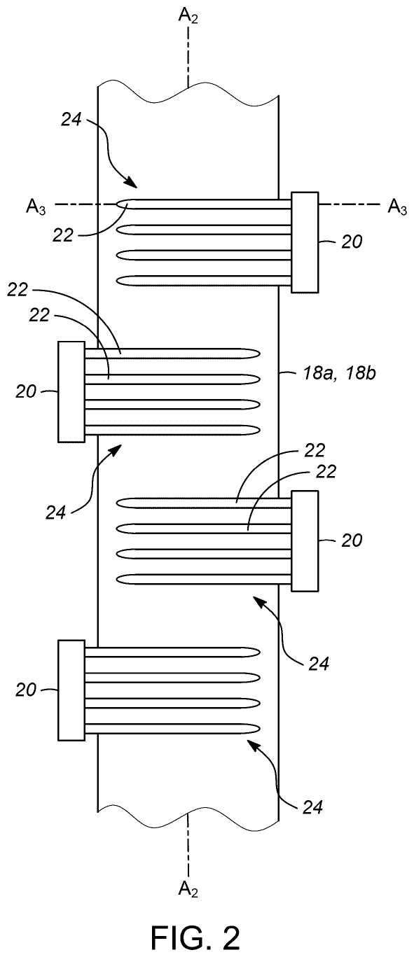

FIG. 2 is a side, cutaway view of a conduit with electric heaters according to one or more aspects of the present invention;

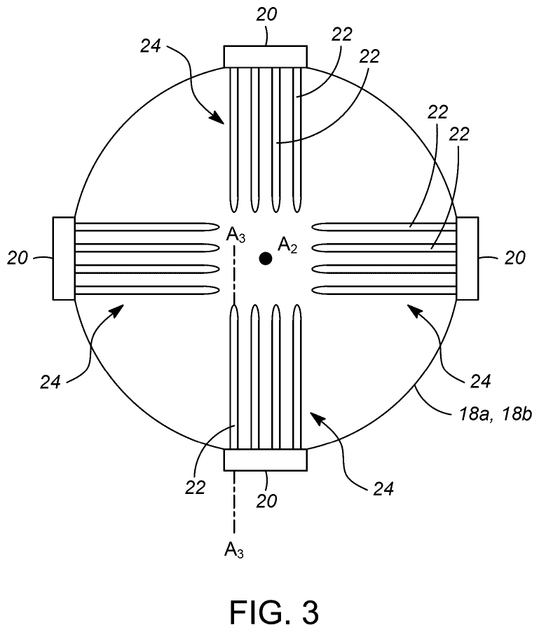

FIG. 3 is a top, schematic view of a conduit with electric heaters according to one or more aspects of the present invention;

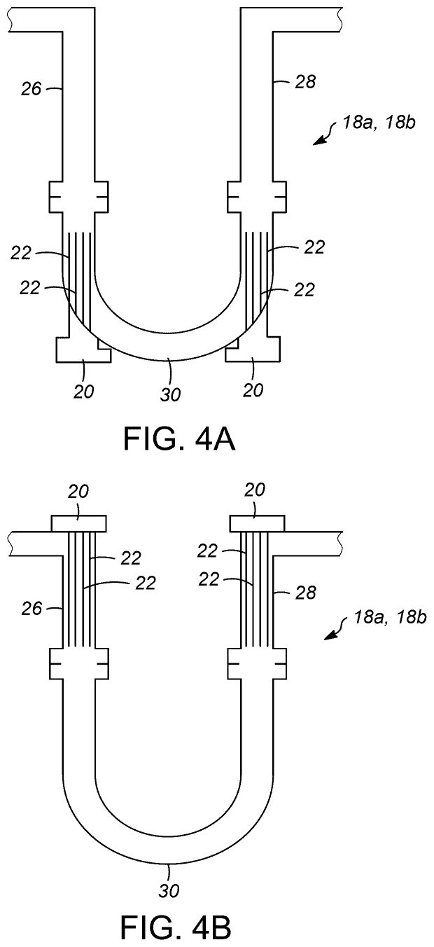

FIG. 4A is a side, cutaway view of another conduit with electric heaters according to one or more aspects of the present invention;

FIG. 4B is a side, cutaway view of a further conduit with electric heaters according to one or more aspects of the present invention;

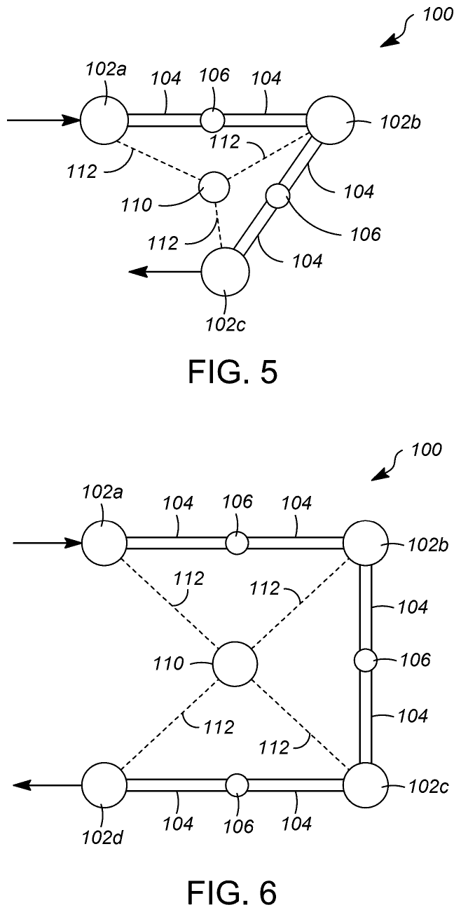

FIG. 5 is a top, schematic view of an arrangement of reactor vessels according to one or more aspects of the present invention;

FIG. 6 is a top, schematic view of another arrangement of reactor vessels according to one or more aspects of the present invention; and,

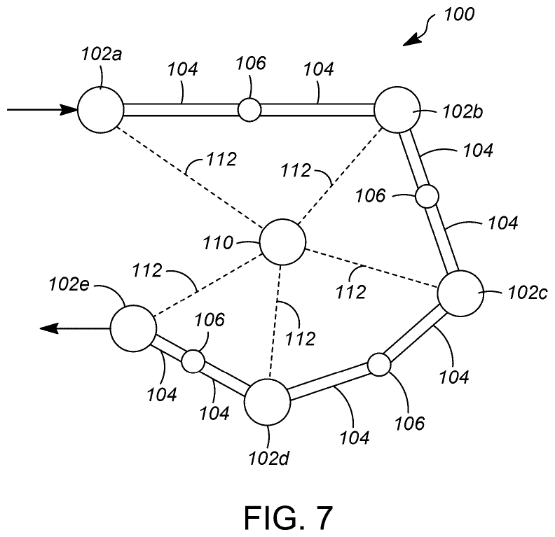

FIG. 7 is a top, schematic view of a further arrangement of reactor vessels according to one or more aspects of the present invention.

### DETAILED DESCRIPTION OF THE INVENTION

As mentioned above, processes and apparatuses have been invented which include an electric heater to provide heat for a chemical reaction. The arrangement is expected to be of smaller footprint than fired heater(s) allowing close-coupling of electric process heater with the inlet and outlet nozzles of the reactor(s) and configured to minimize transfer piping length to/from electric process heater(s). This is expected to lead to a reduction in non-selective thermal cracking, hot volume and pressure drop within the reactor-heater-reactor circuit.

The above-mentioned reductions may enable lower feed consumption, which results in reduction in carbon dioxide footprint of the process. If an electric heater is powered by renewable sources, then further carbon dioxide reduction is also possible. Additionally, a close-coupled electrical process heater arrangement can lead to reduction in costs by minimizing the length of piping between a heater and a reactor.

An electric heater is also an economical and space saving means of increasing process heating duty by adding heating equipment in parallel to a fired heater(s).

An electric heater can be designed to generate a constant or a variable heat flux which could also reduce the heating surface area requirement and thus its footprint as well as tight length and circumference wise control and monitoring of sheath wall temperature (as proxy for film temperature) reducing potential for hot spots. An electric heater equipment platform is amenable to many endothermic chemical processes and can be employed in applications where more carbon dioxide intensive heating methods are currently used.

With these general principles in mind, one or more embodiments of the present invention will be described with the understanding that the following description is not intended to be limiting.

As shown in FIG. 1, according to one or more aspects, the present invention provides an apparatus 10 that includes a plurality of reaction zones, 12a, 12b, 12c in a single stack 13. The depiction of three reaction zones 12a, 12b, 12c is merely exemplary. The reaction zones 12a, 12b, 12c are disposed on top of each other along a longitudinal axis A1-A1 of the stack 13. The reaction zones 12a, 12b, 12c may be radial flow reaction zones. The direction of flow in a radial flow reaction zone may be radially inward (or towards a center pipe) or radially outward (away from a center pipe towards the outer walls).

Each reaction zone 12a, 12b, 12c has an inlet 14a, 14b, 14c for a feed stream comprising hydrocarbons and/or other components and an outlet 16a, 16b, 16c for an effluent. As depicted, the inlets 14a, 14b, 14c of each reaction zone 12a, 12b, 12c are located on the same side and above the outlets 16a, 16b, 16c for the respective reaction zone reaction zone 12a, 12b, 12c. This is merely one arrangement. The inlets 14a, 14b, 14c could be located below the outlets 16a, 16b, 16c. Further, the inlets 14a, 14b, 14c and the outlets 16a, 16b, 16c could be located on opposite sides of the respective reaction zone 12a, 12b, 12c (i.e., one above a reaction zone and the other below the reaction zone).

The reaction zones 12a, 12b, 12c are arranged in series such that an effluent from an upstream reaction zone, e.g., reaction zones 12a, 12b, forms the feed for a downstream reaction zone, e.g., reaction zones 12b, 12c. Accordingly, conduits 18a, 18b are provided to transfer an effluent from the outlet 16a, 16b of a first reaction zone 12a, 12b to the inlet 14b, 14c of a second reaction zone 12b, 12c.

For example, a first conduit 18a is provided between the outlet 16a of the first reaction zone 12a and the inlet 14b of the second reaction zone 12b. Similarly, a second conduit 18b is provided between the outlet 16b of the second reaction zone 12b and the inlet 14c of the third reaction zone 12c.

The conduits 18a, 18b having a longitudinal axis A2-A2 parallel to the longitudinal axis A1-A1 of the stack 13. By “parallel” it is meant that to mean substantially parallel or that the axes are +/−45 degrees, or +/−40 degrees, or +/−30 degrees, or +/−15 degrees from being parallel. The depicted conduits 18a, 18b have the same longitudinal axis A2-A2. This is merely one possibility. Indeed, the conduits 18a, 18b may be located on different sides of the stack 13.

Inside of the reaction zones 12a, 12b, 12c a catalyst may be provided, either in a fixed or moving bed arrangement, which, under suitable conditions, catalyzes a chemical reaction of a component of the feed stream and so that the effluent of the reaction zone 12a, 12b, 12c includes an increased amount of one or more desired products. Alternatively, the reaction zones 12a, 12b, 12c may not include a catalyst and the chemical reaction zone may proceed without a catalyst.

In order for the desired chemical reaction(s) to take place, the feed stream must be heated to a desired or required temperature. In other words, there is a heating requirement for the feed stream. Therefore, in order to provide heat to the feed stream, at least one electric heater 20 is associated with each conduit 18a, 18b to heat the fluid within the conduit 18a, 18b. As is known, the electric heater 20 converts electrical energy to heat, for example via resistance or impedance.

The electric heaters 20 may include a plurality of electric heating elements 22, such as sheathed heaters. As depicted in FIG. 1, the electrical heating elements 22 may be arranged so that longitudinal axes A3-A3 (see FIGS. 2 and 3) of the electric heating elements 22 extend parallel to the longitudinal axis A1-A1 of the apparatus 10 (and the conduit 18).

Turning to FIG. 2, it is also contemplated that the electric heating elements 22 are arranged so that the longitudinal axes A3-A3 of the electric heating elements 22 extend perpendicular to the longitudinal axis A2-A2 of the conduit 18 (and the longitudinal axis A1-A1 of the stack 13 (see FIG. 1)).

Additionally, as can be seen in FIG. 2, the electric heating elements 22 are arranged into bundles 24, or groups of two or more electric heating elements 22. In the embodiment of FIG. 2, the bundles 24 have different directions of insertion into the conduit 18a, 18b. For example, the directions of insertion may alternate for adjacent bundles 24.

In the embodiment of FIG. 3, the directions of insertion, when viewed along the longitudinal axis A2-A2 of the conduit 18 differ. For example, the directions of insertion may rotate between 1 to 179 degrees, or between 20 to 160 degrees, or approximately 90 degrees, between adjacent bundles 24.

Turning to FIGS. 4A and 4B, a conduit 18a, 18b is depicted which has a first leg 26, a second leg 28, and an elbow 30 connecting the first leg 26 and the second leg 28. The electric heater(s) 20 may extend through the elbow 30 (FIG. 4A). It is also contemplated that the electric heater(s) 20 extend towards the elbow 30. See, FIG. 4B. Although, not depicted as such, the two arrangements may be combined.

Returning to FIG. 1, it is contemplated that a second plurality of reaction zones 60a, 60b is provided. Again, each reaction zone 60a, 60b from the second plurality of reaction zones includes an inlet 62a, 62b and an outlet 64a, 64b. The reaction zones 60a, 60b from the second plurality of reaction zones are disposed on top of each other forming a second stack 66. The first plurality of reaction zones 12a, 12b, 12c and the second plurality of reaction zones 60a, 60b are spaced from each other.

The apparatus 10 includes another conduit 18c which transfers an effluent from the outlet 16c of a reaction zone 12c from the first stack 13 to the inlet 62a of a reaction zone 60a from the second stack 66. The conduit 18c also has a longitudinal axis A4-A4 parallel to the longitudinal axis of the stack A1-A1. An electric heater 20 is associated with this conduit 18c to heat the effluent within the conduit 18c. Thus, the electric heater 20 in the conduit 18c may be utilized to heat the fluid as it flows between the reactor stacks 13, 66.

Although it is desired to utilize electric heaters 20, in order to ensure that the fluid reaches the desired or required temperature for the reaction, the apparatus 10 may utilize a fired heater 80. For example, the fired heater 80 may heat the feed stream before it is passed to the first reaction zone 12a. This is merely exemplary.

To reduce the carbon impact associated with the fired heater 80, the fired heater 80 may have an inlet 82 configured to receive a stream of hydrogen fuel 84 which, when mixed with combustion air 86, produces a flame and heat. The use of the stream of hydrogen fuel 84 will reduce the carbon impact which has already been reduced based on the electric heaters provided. The fired heater 80 could also be between one or more reaction zones 12a, 12b, 12c, 60a, 60b.

Turning to FIGS. 5 to 7, the present invention also provides one or more systems 100 with a plurality of reactor vessels 102a, 102b, 102c, 102d, 102e that are arranged in new ways that reduce piping and to provide efficient and efficient arrangements of the reactor vessels.

In particular, the reactor vessels 102a, 102b, 102c, 102d, 102e are arranged in series with a first, or initial, reactor vessel, and a final, or last reactor vessel, with any number of reactor vessels there between. Since the reactor vessels 102a, 102b, 102c, 102d, 102e are arranged in series, an effluent from an upstream reactor is passed, via piping 104, as feed stream to a downstream reactor.

When system 100 is viewed from above, the reactor vessels 102a, 102b, 102c, 102d, 102e form a polygon. By “form a polygon” it is meant that lines connecting the longitudinal axes of the reactor vessels 102a, 102b, 102c, 102d, 102e create a polygon, such as a triangle (FIG. 5), rectangle (FIG. 6), pentagon (FIG. 7), etc. Although depicted with the reactor vessels 102a, 102b, 102c, 102d, 102e have a circular shape with the longitudinal axes at the centers thereof, this is not intended to be limiting. In such a polygon arrangement, the initial reactor vessel and the final reactor vessel are preferably located adjacent to each other. Additionally, in some embodiments, it is contemplated but not required that the reactor vessels 102a, 102b, 102c, 102d, 102e are located at the vertices of the formed polygon.

At least one electric heater 106 is located in the piping 104 between two of the reactor vessels 102a, 102b, 102c, 102d, 102e from the plurality of reactor vessels 102a, 102b, 102c, 102d, 102e. Preferably, an electric heater 106 is disposed in the piping 104 between each of the reactor vessels 102a, 102b, 102c, 102d, 102e. In some embodiments it is contemplated that an electric heater 106 is located at one or more vertices of the formed polygon.

For example, in FIG. 6 there are four reactor vessels, 102a, 102b, 102c, 102d arranged in a rectangle, in particular a square. Electric heaters 106 are disposed in the piping 104 between the first reactor vessel 102a and the second reactor vessel 102b, in the piping 104 between the second reactor vessel 102b and the third reactor vessel 102c, and in the piping 104 between the third reactor vessel 102c and the fourth reactor vessel 102d.

Additionally, as shown in FIGS. 6 and 7, in some systems, the system 100 may further include a regeneration vessel 110 disposed inside of the polygon. In other words, the reactor vessels 102a, 102b, 102c, 102d, 102e are arranged and surround the regeneration vessel 110.

Accordingly, catalyst piping 112 is provided to transfer catalyst from the regeneration vessel 110 to one or more of the reactor vessels 102a, 102b, 102c, 102d, 102e, such as the first, the first and the last, all of the reactor vessels, or any sub-combination of configuration thereof. Again, this arrangement can reduce the catalyst piping 112 needed and thus reduce catalyst loss via attrition.

In any of the foregoing embodiments the heating elements may be arranged so that they have a constant heat flux relative to the direction of flow. Alternatively, the heat flux may not be constant. For example, the heating elements closest to the inlet (or portions of the heating elements closest to the inlet) may have the highest temperature, and the heat flux may decrease towards the outlet, or along the flow path.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### Specific Embodiments

While the following is described in conjunction with specific embodiments, it will be understood that this description is intended to illustrate and not limit the scope of the preceding description and the appended claims.

A first embodiment of the invention is an apparatus comprising a plurality of reaction zones, each reaction zone having an inlet and an outlet, wherein the reaction zones are disposed on top of each other forming a stack having a longitudinal axis; a conduit configured to transfer an effluent from the outlet of a first reaction zone to the inlet of a second reaction zone, the conduit having a longitudinal axis parallel to the longitudinal axis of the stack; and, at least one electric heater associated with the conduit and configured to heat the effluent within the conduit. An embodiment of the invention is one, any or all of prior embodiments in this paragraph up through the first embodiment in this paragraph, further comprising a second conduit configured to transfer an effluent from the outlet of the second reaction zone to the inlet of a third reaction zone, the second conduit having a longitudinal axis parallel to the longitudinal axis of the stack; at least one electric heater associated with the second conduit and configured to heat the effluent within the second conduit. An embodiment of the invention is one, any or all of prior embodiments in this paragraph up through the first embodiment in this paragraph, wherein the at least one electric heater comprises a plurality of electric heating elements, and wherein longitudinal axes of the electric heating elements extend parallel to the longitudinal axis of the stack. An embodiment of the invention is one, any or all of prior embodiments in this paragraph up through the first embodiment in this paragraph, wherein the at least one electric heater comprises a plurality of electric heating elements, and wherein longitudinal axes of the electric heating elements extend perpendicular to the longitudinal axis of the stack. An embodiment of the invention is one, any or all of prior embodiments in this paragraph up through the first embodiment in this paragraph, wherein the electric heating elements are arranged into a plurality of bundles, and wherein the bundles have different directions of insertion into the conduit. An embodiment of the invention is one, any or all of prior embodiments in this paragraph up through the first embodiment in this paragraph, wherein the directions of insertion alternate for adjacent bundles. An embodiment of the invention is one, any or all of prior embodiments in this paragraph up through the first embodiment in this paragraph, wherein the directions of insertion, when viewed along the longitudinal axis of the conduit, rotate by between 1 to 179 degrees, or between 20 to 160 degrees, or approximately 90 degrees. An embodiment of the invention is one, any or all of prior embodiments in this paragraph up through the first embodiment in this paragraph, wherein the conduit comprises a first leg, a second leg, and an elbow connecting the first leg and the second leg. An embodiment of the invention is one, any or all of prior embodiments in this paragraph up through the first embodiment in this paragraph, wherein the at least one electric heater extends through the elbow. An embodiment of the invention is one, any or all of prior embodiments in this paragraph up through the first embodiment in this paragraph, further comprising a second plurality of reaction zones, each reaction zone from the second plurality of reaction zones having an inlet and an outlet, wherein the reaction zones from the second plurality of reaction zones are disposed on top of each other forming a second stack; a second conduit configured to transfer an effluent from the outlet of the second reaction zone to the inlet of a third reaction zone, the second conduit having a longitudinal axis parallel to the longitudinal axis of the stack; at least one electric heater associated with the second conduit and configured to heat the effluent within the second conduit, wherein the third reaction zone is from the second plurality of reaction zones. An embodiment of the invention is one, any or all of prior embodiments in this paragraph up through the first embodiment in this paragraph, further comprising a fired heater configured to heat a stream associated with a reaction zone from the plurality of reaction zones, wherein the fired heater comprises an inlet configured to receive a stream of a hydrogen fuel. An embodiment of the invention is one, any or all of prior embodiments in this paragraph up through the first embodiment in this paragraph, wherein the reaction zones comprise radial flow reaction zones.

A second embodiment of the invention is a system comprising a plurality of reactor vessels, the reactor vessels arranged in series with a first reactor and a last reactor, and, when viewed from above, the plurality of reactor vessels form a polygon, piping configured to transfer an effluent from an upstream reactor vessel from the plurality of reactor vessels to a downstream reactor vessel from the plurality of reactor vessels, and, at least one electric heater disposed in the piping between two of the reactor vessels from the plurality of reactor vessels. An embodiment of the invention is one, any or all of prior embodiments in this paragraph up through the second embodiment in this paragraph, further comprising an electric heater disposed in the piping between each of the reactor vessels from the plurality of reactor vessels. An embodiment of the invention is one, any or all of prior embodiments in this paragraph up through the second embodiment in this paragraph, wherein the polygon is a rectangle. An embodiment of the invention is one, any or all of prior embodiments in this paragraph up through the second embodiment in this paragraph, wherein the reactor vessels from the plurality of reactor vessels are located at vertices of the polygon. An embodiment of the invention is one, any or all of prior embodiments in this paragraph up through the second embodiment in this paragraph, further comprising an electric heater at each vertex of the polygon. An embodiment of the invention is one, any or all of prior embodiments in this paragraph up through the second embodiment in this paragraph, further comprising a regeneration vessel disposed, inside of the polygon; and, piping configured to provide catalyst from the regeneration vessel to at least one of the reactor vessels from the plurality of reactor vessels. An embodiment of the invention is one, any or all of prior embodiments in this paragraph up through the second embodiment in this paragraph, wherein the at least one of the reactor vessels comprises the first reactor vessel, or the last reactor vessel, or both. An embodiment of the invention is one, any or all of prior embodiments in this paragraph up through the second embodiment in this paragraph, wherein the plurality of reactor vessels comprises four reactor vessels and the polygon is a rectangle, and wherein an electric heater is disposed in the piping between each of the four reactor vessels.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An apparatus comprising:
a plurality of reaction zones, each reaction zone having an inlet and an outlet, wherein the reaction zones are disposed on top of each other forming a stack having a longitudinal axis;
a conduit configured to transfer an effluent from the outlet of a first reaction zone to the inlet of a second reaction zone, the conduit having a longitudinal axis parallel to the longitudinal axis of the stack; and,
at least one electric heater associated with the conduit and configured to heat the effluent within the conduit.

2. The apparatus of claim 1, further comprising:
a second conduit configured to transfer an effluent from the outlet of the second reaction zone to the inlet of a third reaction zone, the second conduit having a longitudinal axis parallel to the longitudinal axis of the stack;
at least one electric heater associated with the second conduit and configured to heat the effluent within the second conduit.

3. The apparatus of claim 1, wherein the at least one electric heater comprises a plurality of electric heating elements,
and wherein longitudinal axes of the electric heating elements extend parallel to the longitudinal axis of the stack.

4. The apparatus of claim 1, wherein the at least one electric heater comprises a plurality of electric heating elements,
and wherein longitudinal axes of the electric heating elements extend perpendicular to the longitudinal axis of the stack.

5. The apparatus of claim 4, wherein the electric heating elements are arranged into a plurality of bundles, and wherein the bundles have different directions of insertion into the conduit.

6. The apparatus of claim 5, wherein the directions of insertion alternate for adjacent bundles.

7. The apparatus of claim 5, wherein the directions of insertion, when viewed along the longitudinal axis of the conduit, rotate by between 1 to 179 degrees, or between 20 to 160 degrees, or approximately 90 degrees.

8. The apparatus of claim 1, wherein the conduit comprises a first leg, a second leg, and an elbow connecting the first leg and the second leg.

9. The apparatus of claim 8, wherein the at least one electric heater extends through the elbow.

10. The apparatus of claim 1, further comprising:
a second plurality of reaction zones, each reaction zone from the second plurality of reaction zones having an inlet and an outlet, wherein the reaction zones from the second plurality of reaction zones are disposed on top of each other forming a second stack;
a second conduit configured to transfer an effluent from the outlet of the second reaction zone to the inlet of a third reaction zone, the second conduit having a longitudinal axis parallel to the longitudinal axis of the stack;
at least one electric heater associated with the second conduit and configured to heat the effluent within the second conduit,
wherein the third reaction zone is from the second plurality of reaction zones.

11. The apparatus of claim 1, further comprising a fired heater configured to heat a stream associated with a reaction zone from the plurality of reaction zones,
wherein the fired heater comprises an inlet configured to receive a stream of a hydrogen fuel.

12. The apparatus of claim 1, wherein the reaction zones comprise radial flow reaction zones.

13. A system comprising:
a plurality of reactor vessels, the reactor vessels arranged in series with a first reactor and a last reactor, and, when viewed from above, the plurality of reactor vessels form a polygon,
piping configured to transfer an effluent from an upstream reactor vessel from the plurality of reactor vessels to a downstream reactor vessel from the plurality of reactor vessels, and,
at least one electric heater disposed in the piping between two of the reactor vessels from the plurality of reactor vessels.

14. The system of claim 13, further comprising:
an electric heater disposed in the piping between each of the reactor vessels from the plurality of reactor vessels.

15. The system of claim 13, wherein the polygon is a rectangle.

16. The system of claim 13, wherein the reactor vessels from the plurality of reactor vessels are located at vertices of the polygon.

17. The system of claim 13, further comprising:
an electric heater at each vertex of the polygon.

18. The system of claim 13, further comprising:
a regeneration vessel disposed, inside of the polygon; and,
piping configured to provide catalyst from the regeneration vessel to at least one of the reactor vessels from the plurality of reactor vessels.

19. The system of claim 18, wherein the at least one of the reactor vessels comprises the first reactor vessel, or the last reactor vessel, or both.

20. The system of claim 18, wherein the plurality of reactor vessels comprises four reactor vessels and the polygon is a rectangle, and
wherein an electric heater is disposed in the piping between each of the four reactor vessels.
